(19) United States
(12) Patent Application Publication
(10) Pub. No.: US 2005/0286682 A1
(43) Pub. Date: Dec. 29, 2005

(54) Detector for radiation imaging systems

(75) Inventors: John Eric Tkaczyk, Delanson, NY (US); William Edward Burdick JR., Schenectady, NY (US); Naresh Kesavan Rao, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/881,950

(22) Filed: Jun. 29, 2004

(51) Int. Cl. H05G 1/64

(52) U.S. Cl. 378/98.8

(57) ABSTRACT

A detector module for use in an imaging system is provided. The detector comprises at least one sensor array configured for receiving X-ray signals and converting the X-ray signals to corresponding electrical signals, at least one electronic device configured for converting the electrical signals to a corresponding digital signal and a switching circuit coupling the sensor array and the electronic device, wherein the switching circuit is configured for routing the electrical signals from the sensor array to the electronic device.

### BACKGROUND

The invention relates generally to imaging systems and more specifically to a detector system for a radiation imaging system.

Many imaging systems may require flexible routing and switching of signals between the sensor array and readout electronic device channels. Some of the reasons for such a requirement include better electrical performance, larger dynamic range of the readout electronics, better image quality and larger detector area. In applications such as volumetric CT systems require detectors with large area arrays.

The limited dynamic range of the readout electronics can be addressed by static binning of pixels using field effect transistor (FET) switches. For example, for a CT scan with low signal level, the FET switches are set so as to combine signals from different pixels into a single ASIC channel. The FETs are typically formed on a bare silicon die and mounted on a detector module in close proximity to the x-ray sensor. Typically, the pads of the FETs are electrically connected, e.g., wire-bonded to the sensor pixel array and to the ASIC board. Often, the sensor contacts are formed on the same side as that receiving the x-ray signal resulting in a reduction of active area available for detecting X-rays.

It is also desired to dynamically route multiple electrical signals from pixels to an electronic device using a single channel. The dynamic routing, in time, of multiple pixel signals to a single channel is generally accomplished using high bandwidth FETs, which operate in real time whereby all the appropriate pixels during a view are readout through the designated channel. Such dynamic FETs are usually packaged in as a separate component and mounted to a printed circuit board, far from the sensor. In addition, the remote mounting if the FET requires that the connections for every pixel to be routed to the board.

Another reason to route signals dynamically is to provide a dithering function where the signals from neighboring channels are routed to different electronic devices usually application specific integrated devices (ASICs). For examples, in CT systems, the benefit of dithering is that the difference in linearity of one ASIC relative to another creates a checkerboard pattern in the reconstructed image when viewed in combination with the background noise of a CT system. Typically, dithering is accomplished by routing signals on printed circuit boards. One problem with printed circuit boards is the large dimensions of electrically conducting trace widths thus requiring large board area and several conducting layers to accomplish the dithering.

Another desirable feature for detectors is large detector area. One problem with designing detectors with large areas is the introduction of electronic noise which effects the electrical performance of the detector. Possible sources of electronic noise include poor design of trace routing, i.e., the self-capacitance of long traces and other electronic devices in close proximity to the traces. In addition, the capacitance between traces lead to channel-to-channel crosstalk can contribute electronic noise.

A further feature desirable for large detector area is to place the switching circuit in closest proximity to the sensor array thus creating minimum capacitance between the sensor array and switching circuit. Such a physical configuration substantially improves the noise performance and efficiency of two important acquisition modes, which are, correlated double sampling and charge-storage acquisition sequencing. Correlated double sampling is an acquisition sequencing mechanism known in the art of analog electronics for reducing noise and charge-storage is a mechanism for sequencing multiple pixels to a single amplifier channel. Typically, in conventional detectors, the switching circuit is present as a discrete circuit mounted on a board or substrate at some distance from the sensor itself. The routing between the sensor and switch circuit contributes significant capacitance (about ten to hundreds of picofarads), which reduces the effectiveness of the two acquisition modes.

Another problem present in most detector systems, are the creation of block artifacts when one readout electronic device converts charge to digital signals with a slightly different proportionality than another. The difference may be present at low or high signal values corresponding to offset or gain differences in the electronic devices respectively.

In addition, the sensor connection array pattern may not be the same as the connection array of the electronic device. Often the electronic device is smaller in area then the sensor array and its contacts at a finer pitch. The difference in the array patterns may also introduce noise. In addition, changes in pixel pitch are generally obtained by routing multi-layer flex circuits between the sensor and the electronic device. Generally the lengths of these traces are long and induce additional capacitance and noise into the signal path.

Therefore, there is a need to design detectors with large detector areas while improving the electrical performance, dynamic range of the readout electronics, as well as providing better image quality.

### BRIEF DESCRIPTION

Briefly, according to one aspect of the invention, a detector for use in an imaging system is provided. The detector comprises at least one sensor array configured for receiving X-ray signals and converting the X-ray signals to corresponding electrical signals, at least one electronic device configured for converting the electrical signals to a corresponding digital signal and a switching circuit coupling the sensor array and the electronic device, wherein the switching circuit is configured for routing the electrical signals from the sensor array to the electronic device.

In another embodiment, a radiation imaging system for generating an image of an object is provided. The imaging system comprises an X-ray source disposed in a spatial relationship to the object configured to transmit X-ray radiation through the object, at least one integrated detector module configured to convert the X-ray radiation to corresponding electrical signals and a processor for processing the electrical signals to generate the image of the object. The detector comprises at least one sensor array configured for receiving X-ray signals and converting the X-ray signals to corresponding electrical signals, at least one electronic device configured for converting the electrical signals to a corresponding digital signal and at least one switching circuit coupling the sensor array and the electronic device wherein the switching circuit is configured for routing the electrical signals from the sensor array to the electronic device.

In a further embodiment, a computed tomography (CT) system for generating an image of an object is provided. The CT system comprises an X-ray source configured to emit a stream of radiation, at least one integrated detector module configured to convert the X-ray radiation to corresponding electrical signals and a processor for processing the electrical signals to generate the image of the object. The detector comprises at least one sensor array configured for receiving X-ray signals and converting the X-ray signals to corresponding electrical signals, at least one electronic device configured for converting the electrical signals to a corresponding digital signal and at least one switching circuit coupling the sensor array and the electronic device wherein the switching circuit is configured for routing the electrical signals from the sensor array to the electronic device.

In another embodiment, an integrated sensor array kit is provided. The integrated sensor array kit comprises at least one sensor array configured for receiving X-ray signals and converting the X-ray signals to corresponding electrical signals and at least one electronic device configured for converting the electrical signals to a corresponding digital signal. The sensor array further comprises and at least one switching circuit coupling the sensor array and the electronic device wherein the switching circuit is configured for routing the electrical signals from the sensor array to the electronic device. The switching circuit comprises an interposer circuit comprising a first side and a second side and wherein the interposer circuit is disposed between the sensor array to the electronic device and is configured for coupling the sensor array to the electronic device. A through-via is provided for electrically coupling the first side and the second side. The sensor array kit further comprises a flexible printed circuit disposed below the interposer, wherein the electronic device is mounted on the flexible printed circuit.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram illustrating one embodiment of a detector implemented according to an aspect of the invention where switchable routing is interposed between the sensor and readout electronics;

FIG. 2 is a side view of one embodiment of a detector implemented according to one aspect of the invention where a sensor array and an electronic device are mounted on opposite sides of an interposer;

FIG. 3 is a top view of an embodiment of an interposer circuit implemented according to one aspect of the invention showing an array of contacts pads corresponding to a sensor array configuration;

FIG. 4 is a bottom view of an embodiment of an interposer circuit implemented according to one aspect of the invention illustrating showing an array of contacts pads disposed on a second side of the interposer circuit;

FIG. 5 is a cross-sectional view of an embodiment of an interposer circuit implemented according to one aspect of the invention where through-vias electrically couple contact pads on a first side of an interposer circuit to contact pads on a second side of an interposer circuit;

FIG. 6 is a side view of an embodiment of a detector comprising a flexible printed circuit implemented according to one aspect of the invention;

FIG. 7, FIG. 8 and FIG. 9 are various embodiments of detector comprising switching circuit and the flexible printed circuit; and

FIG. 10 is a block diagram illustrating one embodiment of an imaging system implemented according to one aspect of the invention.

### DETAILED DESCRIPTION

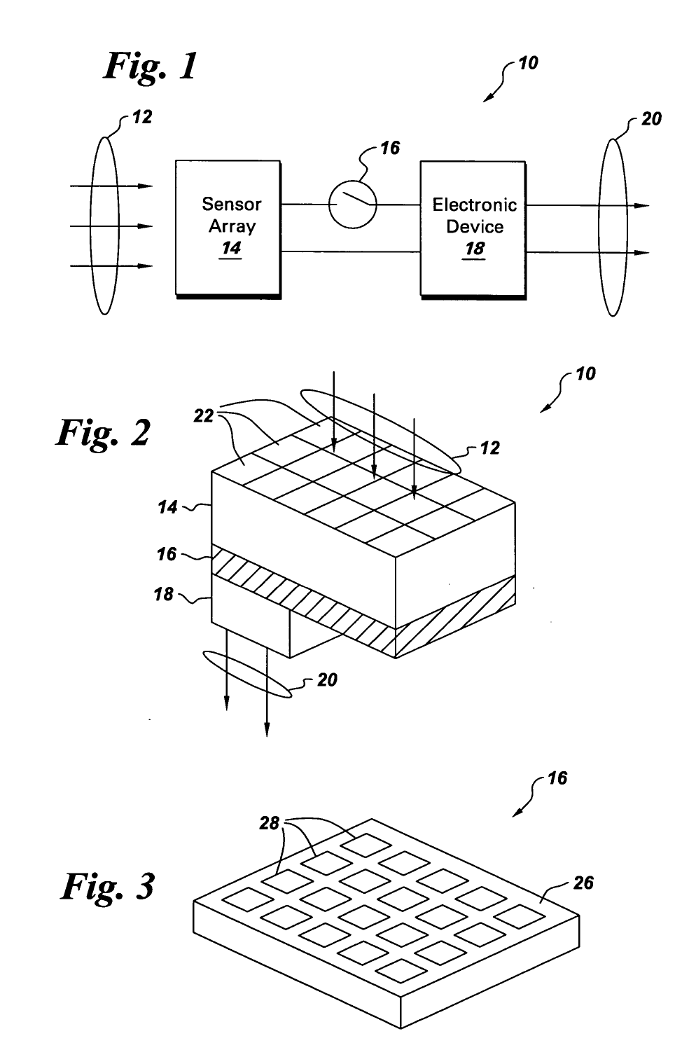

FIG. 1 is a block diagram of a detector module adapted for use in an x-ray imaging system. Examples of x-ray imaging systems include computed tomosynthesis systems, positron emission tomography systems, etc. The detector module 10 is an integrated structure comprising sensor array 14, switching circuit 16 and electronic device 18. Each component is described in further detail below.

As used herein, “adapted to”, “configured” and the like refer to devices in a system to allow the elements of the system to cooperate to provide a described effect; these terms also refer to operation capabilities of electrical or optical elements such as analog or digital computers or application specific devices (such as an application specific integrated circuit (ASIC)), amplifiers or the like that are programmed to provide an output in response to given input signals, and to mechanical devices for optically or electrically coupling components together.

Sensor array 14 is configured for receiving X-ray signals 12 and converting the X-ray signals to corresponding electrical signals. Sensor array 16 includes a plurality of pixels 22 and comprises X-ray detecting material such as scintillators with photodiode and direct conversion materials. In an example embodiment, the sensor array may include for example X-ray detecting media configured to convert the X-ray radiation to corresponding electrical signals.

Electronic device 18 is configured for converting the electrical signals to corresponding digital signals 20. Electronic device 18 may include components such as amplifiers, capacitors, samplers, etc which are not shown in FIG. 1. The digital signals may be provided to an image processor where the digital signals may be processed to generate a corresponding image.

Switching circuit 16 is configured for coupling the sensor array 14 and the electronic device 18. The switching circuit is configured for routing the electrical signals from the pixels in the sensor array to the electronic device. In one embodiment, the switching circuit comprises an interposer circuit. By disposing the switching circuit just below the sensor array, the capacitance between the sensor array the switching circuit is reduced substantially, therefore improving electrical performance including the reduction of overall noise. In addition, correlated double sampling of channels of the electronic device is achieved by disposing the switching circuit near the sensor array thus further reducing noise on interconnection traces. As the signals are routed within the detector module, butt-ability is provided on the sides of the detector module. Thus, a large area detector array can be created as several such detector modules may be added on the detector module 10 forming a two dimensional array.

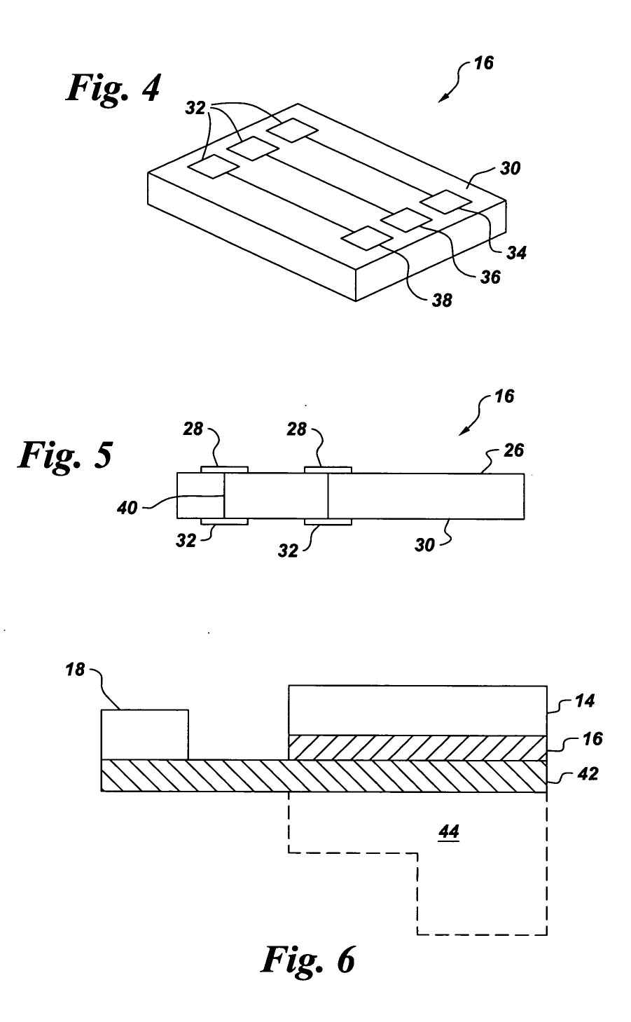

FIG. 2 is a side view of detector 10 used for sensing X-ray signals 12 and generating corresponding digital signals 20. In the illustrated embodiment, the sensor array is shown comprising a plurality of pixels 22. The sensor array may comprise scintillator materials and photodiodes. In an alternate embodiment, the sensor array comprises a single layer of a direct conversion material. Examples of direct conversion materials include cadmium telluride, cadmium zinc telluride crystals, polycrystalline compacts and film layers. In the illustrated embodiment switching circuit 16 is a silicon interposer circuit. The silicon interposer circuit is coupled to electronic device 18. The silicon interposer circuit is described in further detail below with reference to FIG. 3, FIG. 4 and FIG. 5.

FIG. 3 is a top view of an embodiment of the interposer circuit. The interposer is typically fabricated with a silicon substrate which has the highest trace routing capability. However, those skilled in the art will recognize that the interposer's substrate material could comprise any semiconductor material, including, silicon, silicon carbide, gallium arsenide, etc. In addition, organic and non-organic polymeric materials can be configured with trace routing and through-vias so as to meet the functional requirements of an interposer. An advantage of fabricating the interposer using semiconductor material, is that standard wafer processes can be employed to fabricate the interposer, including creating input/output contacts on the interposer at the very fine pitches achievable using wafer processing. Further, the interposer material can be selected based on its properties to support optimal mechanical and thermal performance.

The interposer circuit is shown comprising a first side 26. The first side 26 comprises several contact pads 28. In one embodiment, the first side of the interposer comprises a contact pad for each pixel in the sensor array. Each contact pad may be placed to correspond to pixel contacts in the sensor array. The contact pads are configured for coupling the sensor array 14 with the first side of the interposer circuit.

FIG. 4 is a bottom view of one embodiment of the interposer circuit. The interposer circuit comprises a second side 30 configured for coupling the interposer to the electronic device. The second side comprises contact pads 32 that are coupled to electrical switches 34, 36 and 38. The electrical switches are configured to multiplex electrical signals from the sensor array to a desired channel in the electronic device. In a specific embodiment, of the invention, electrical signals from various pixels may be routed through a single channel in the electronic device.

Examples of electrical switches include field effect transistors, diodes configured as switches, capacitor switches and the like. In one specific embodiment of the interposer circuit, the electrical switches may couple traces from the sensor array 14 (shown in FIG. 1) to the electronic device 18 (shown in FIG. 1). The second side may further comprise a control line (not shown) for coupling a gate line of the switch to a control line of a control system in the electronic device.

FIG. 5 shows a cross-sectional side view of one embodiment of the interposer circuit 16. Through-via 40 is configured for electrically coupling the first side 26 and the second side 30. The through-vias may be a regular array or may be clustered in one area of the interposer circuit.

In a further embodiment, the detector 10 of FIG. 1 further comprises a flexible printed circuit 42 as shown in FIG. 6. A flexible interconnect may also be used in place of the flexible printed circuit. The flexible printed circuit may be disposed below the interposer circuit as shown in FIG. 6. Electronic device 18 is disposed on the flexible printed circuit 42. The electronic device can be mounted on any portion of the flexible printed circuit thus enabling the easier addition of non-electrical devices such as mechanical supports, etc on detector 10. Backplane 44 refers to the mechanical support of the switching circuit 16 which may comprise a supporting structure of ceramic, plastic, metallic or combination of materials. Generally, the backplane will serve both mechanical and thermal functions.

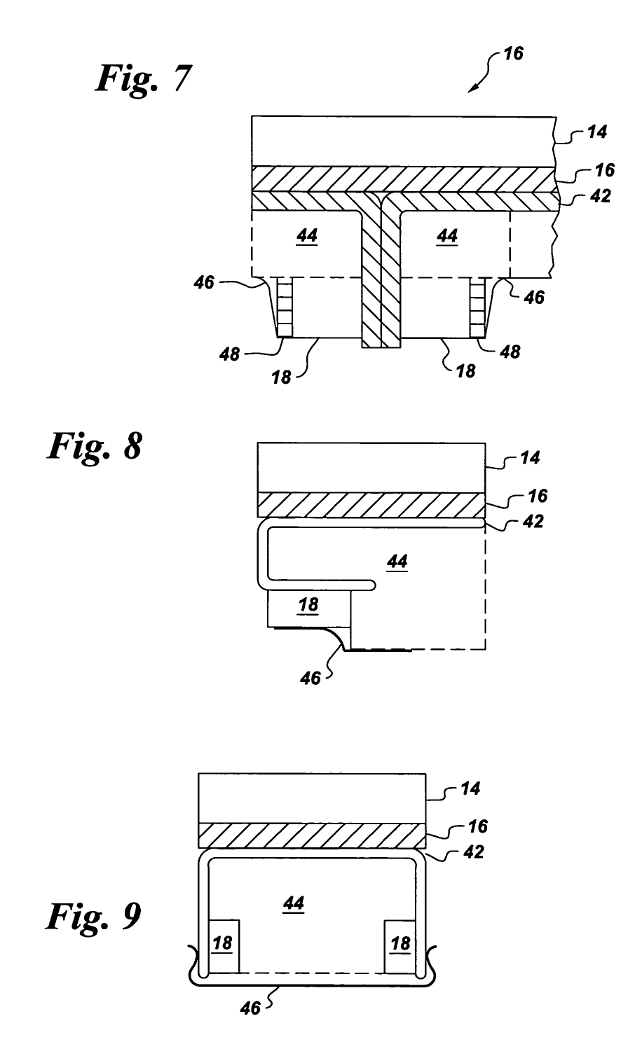

FIG. 7, FIG. 8 and FIG. 9 are various embodiments of detector 10 comprising switching circuit 16 and the flexible printed circuit 42. FIG. 7 is an embodiment where the flexible printed circuit is disposed below the switching circuit 16 in a ‘T’ shape. Backplane 44 refers to the mechanical support of the switching circuit 16. Clamp 46 is a mechanical support for readout circuit 18. Heat spreader layer 48 is disposed below electronic device 18 to dissipate heat that s generated by the electronic device.

Similarly, FIG. 8 is an embodiment where the flexible printed circuit is disposed below the switching circuit 16 in a ‘C’ shape and FIG. 9 is an embodiment where the flexible printed circuit is disposed below the switching circuit 16 in a ‘U’ shape. Other shapes and configurations for the flexible interconnect from the sensor to the electronic device, although not detailed, are possible.

The above described embodiments of the integrated detector module 10 may be implemented in various radiation imaging systems such as CT systems. Other imaging modalities, which acquire image data for a volume, may also benefit from the described invention. The following discussion of CT systems is merely an example of one such implementation and is not intended to be limiting in terms of modality or anatomy. The invention may also be used in other systems such as ultrasound systems, optical systems, thermal systems, etc that senses signals of one form and converts the same to signals of another form.

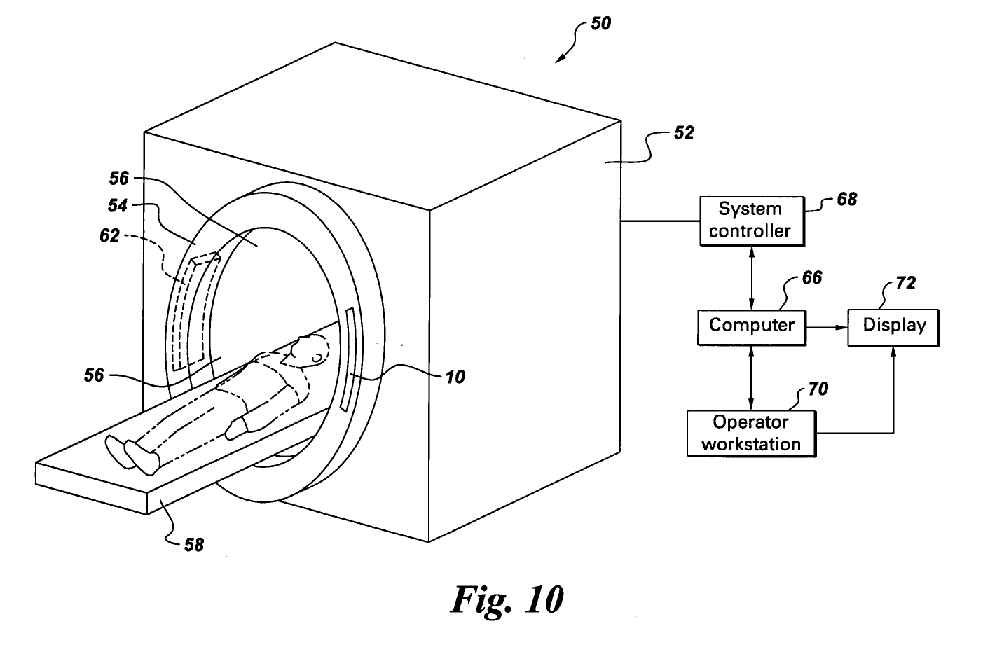

FIG. 10 is an exemplary CT scanning system 50 used for imaging a portion of an imaging subject 64. The CT scanning system 50 is illustrated with a frame 52 and a gantry 54 having an aperture 56. Further, a table 58 is illustrated positioned in the aperture 56 of the frame 52 and the gantry 54. The gantry 54 is illustrated with the source of radiation 12, typically an X-ray tube 62 that emits X-ray radiation. In typical operation, X-ray source 62 projects an X-ray beam toward detector module 10.

Detector module 10 is an integrated structure comprising a sensor array, a switching circuit and an electronic device as described with reference to FIG. 1 and FIG. 2. The detector module comprises at least one sensor array configured for receiving X-Ray signals and converting the X-Ray signals to corresponding electrical signals, at least one electronic device configured for converting the electrical signals to a corresponding digital signal, and a switching circuit coupling the sensor array and the electronic device, wherein the switching circuit is configured for routing the electrical signals from the sensor array to the electronic device and wherein the switching circuit, the sensor array and the electronic device form an integrated structure.

Data from the detector module 10 is filtered and backprojected by processor 66 to formulate an image of the scanned area. The processor 66 is typically used to control the entire CT system 10. The main processor that controls the operation of the system may be adapted to control features enabled by the system controller 68. Further, the operator workstation 70 is coupled to the processor 66 as well as to a display 72, so that the reconstructed image may be viewed. Alternatively, some or all of the processing described herein may be performed remotely by additional computing resources based upon raw or partially processed image data.

The above described invention provides many advantages including providing flexible routing of the signals between the sensor array and electronic device. All circuits for providing various functions such as multiplexing, binning, etc. can be fabricated in a single chip thus making the system more compact and reliable.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A detector module for use in an imaging system, the detector module comprising:
at least one sensor array configured for receiving X-ray signals and converting the X-ray signals to corresponding electrical signals;
at least one electronic device configured for converting the electrical signals to corresponding digital signals; and
a switching circuit coupling the sensor array and the electronic device, wherein the switching circuit is configured for routing the electrical signals from the sensor array to the electronic device and wherein the switching circuit, the sensor array and the electronic device form an integrated structure.

2. The detector of claim 1, wherein the switching circuit comprises an interposer circuit comprising a first side and a second side and wherein the interposer circuit is disposed between the sensor array to the electronic device and is configured for coupling the sensor array to the electronic device.

3. The detector of claim 2, wherein the first side of the interposer circuit comprises at least one contact pad, the first side configured for coupling the interposer to the sensor array.

4. The detector of claim 2, wherein the second side comprises at least one electrical switch, the second side configured for coupling the interposer to the electronic device and to route the electrical signals from the sensor array to the electronic device.

5. The detector of claim 2, further comprising a through-via configured for electrically coupling the first side and the second side.

6. The detector of claim 2, further comprising a flexible printed circuit or flexible interconnect disposed on a lower surface of the interposer.

7. The detector of claim 6, wherein the electronic device is mounted on the flexible printed circuit.

8. The detector of claim 1, wherein the sensor array comprises an x-ray detecting medium.

9. The detector of claim 1, wherein the sensor array comprises a single direct conversion material.

10. A radiation imaging system for generating an image of an object, the imaging system comprising:
an X-ray source disposed in a spatial relationship to the object configured to transmit X-ray radiation through the object;
at least one integrated detector module configured to convert the X-ray radiation to corresponding electrical signals; wherein the detector module comprises:
at least one sensor array configured for receiving X-ray signals and converting the X-ray signals to corresponding electrical signals;
at least one electronic device configured for converting the electrical signals to a corresponding digital signal;
at least one switching circuit coupling the sensor array and the electronic device wherein the switching circuit is configured for routing the electrical signals from the sensor array to the electronic device; and
a processor for processing the electrical signals to generate the image of the object.

11. The radiation imaging system of claim 10, wherein the switching circuit comprises an interposer circuit comprising a first side and a second side configured for coupling the sensor array to the electronic device; wherein the first side of the interposer circuit comprises at least one contact pad, and is configured for coupling the interposer to the sensor array.

12. The radiation imaging system of claim 10, wherein the second side comprises at least one electrical switch, the second side configured for coupling the interposer to the electronic device.

13. The radiation imaging system of claim 10, further comprising a through-via configured for electrically coupling the first side and the second side.

14. The radiation imaging system of claim 10, further comprising a flexible printed circuit or flexible interconnect disposed below the interposer.

15. The radiation imaging system of claim 14, wherein the electronic device is mounted on the flexible printed circuit.

16. A computer tomography (CT) system for generating an image of an object, comprising:
an X-ray source configured to emit a stream of radiation;
at least one integrated detector module configured to convert the X-ray radiation to corresponding electrical signals; wherein the detector comprises:
at least one sensor array configured for receiving X-ray signals and converting the X-ray signals to corresponding electrical signals;
at least one electronic device configured for converting the electrical signals to a corresponding digital signal;
at least one switching circuit coupling the sensor array and the electronic device wherein the switching circuit is configured for routing the electrical signals from the sensor array to the electronic device; and
a processor for processing the electrical signals to generate the image of the object.

17. The CT system of claim 16, wherein the switching circuit comprises an interposer circuit comprising a first side and a second side and wherein the interposer circuit is disposed between the sensor array to the electronic device and is configured for coupling the sensor array to the electronic device.

18. An integrated sensor array kit comprising:
at least one sensor array configured for receiving X-ray signals and converting the X-ray signals to corresponding electrical signals;
at least one electronic device configured for converting the electrical signals to a corresponding digital signal;
at least one switching circuit coupling the sensor array and the electronic device wherein the switching circuit is configured for routing the electrical signals from the sensor array to the electronic device; wherein the switch circuit comprises an interposer circuit comprising a first side and a second side and wherein the interposer circuit is disposed between the sensor array to the electronic device and is configured for coupling the sensor array to the electronic device;
a through-via configured for electrically coupling the first side and the second side; and
a flexible printed circuit or flexible interconnect disposed below the interposer, wherein the electronic device is mounted on the flexible printed circuit.
